(19) United States
(12) Patent Application Publication
(10) Pub. No.: US 2005/0033875 A1
(43) Pub. Date: Feb. 10, 2005

(54) System and method for selectively affecting data flow to or from a memory device

(76) Inventors: Frank Nam Go Cheung, Agoura Hills, CA (US); Richard Chin, Torrance, CA (US)

Correspondence Address: Patent Docket Administration, 2000 E. El Segundo Boulevard, P.O. Box 902 (EO/EO4/N119), El Segundo, CA, 90245-0902, US

(21) Appl. No.: 10/878,893

(22) Filed: Jun. 28, 2004

Related U.S. Application Data
(60) Provisional application No. 60/483,999, filed on Jun. 30, 2003.
(60) Provisional application No. 60/484,025, filed on Jun. 30, 2003.

(51) Int. Cl. G06F 3/00

(52) U.S. Cl. 710/29

(57) ABSTRACT

A system for selectively affecting data flow to and/or from a memory device. The system includes a first mechanism for intercepting data bound for the memory device or originating from the memory device. A second mechanism compares a data level associated with the first mechanism to one or more thresholds and provides a signal in response thereto. A third mechanism selectively releases data from the first mechanism or from the memory device in response to the signal. In the specific embodiment, the first mechanism includes one or more First-In-First-Out (FIFO) memory buffers having level indicators that provide data level information. The third mechanism includes a memory manager that provides the signal to the one or more FIFO buffers or to the memory device based on the data level information, thereby causing the one or more FIFO buffers to release the data or accept data from the memory device.

### CLAIM OF PRIORITY

This application claims priority from U.S. Provisional Patent Application Ser. No. 60/483,999 filed Jun. 30, 2003, entitled DATA LEVEL BASED ESDRAM/SDRAM MEMORY A RBITRATOR TO ENABLE SINGLE MEMORY FOR ALL VIDEO FUNCTIONS, which is hereby incorporated by reference. This application claims also priority from U.S. Provisional Patent Application Ser. No. 60/484,025, filed Jun. 30, 2003, entitled CYCLE TIME IMPROVED ESDRAM/SDRAM CONTROLLER FOR FREQUENT CROSS-PAGE AND SEQUENTIAL ACCESS APPLICATIONS, which is hereby incorporated by reference.

### BACKGROUND OF THE INVENTION

1. Field of Invention

This invention relates to memory devices. Specifically, the present invention relates to systems and methods for affecting data flow to and/or from a memory device.

2. Description of the Related Art

Memory devices are employed in various applications including personal computers, miniature unmanned aerial vehicles, and so on. Such applications demand fast memories and associated controllers and arbitrators that can efficiently handle data bursts, variable data rates, and/or time-staggered data between the memories and accompanying systems.

Efficient memory data flow control mechanisms, such as memory data arbitrators, are particularly important in SDRAM (Synchronous Dynamic Random Access Memory) and ESDRAM (Enhanced SDRAM) applications, VCM (Virtual channel Memory), SSRAM (synchronous SRAM), and other memory devices with sequential data burst capabilities. Data arbitrators facilitate preventing memory overflow or underflow to/from various ESDRAM/SDRAM memories, especially in applications wherein numbers of data inputs and outputs exceed numbers of memory banks.

Memory data arbitrators may employ parallel-to-serial converters to write data from a processor to a memory and serial-to-parallel converters to read data from the memory to the processor. The converters often include a timing sequencer that employs timing and scheduling routines to selectively control data flow to and from the memory via the parallel-to-serial and serial-to-parallel converters to prevent data overflow or underflow.

Unfortunately, conventional timing sequencers often do not efficiently accommodate variable data rates, data bursts, or time-staggered data. This limits memory capabilities, resulting in larger, less-efficient, expensive systems.

Furthermore, conventional timing sequencers and data arbitrators often yield undesirable system design constraints. For example, when system data path pipeline delays are added or removed, arbitrator timing must be modified accordingly, which is often time-consuming and costly. In some instances, requisite timing modifications are prohibitive. For example, conventional timing sequencers often cannot be modified to accommodate instances wherein data must be simultaneously written to plural data banks in an SDRAM/ESDRAM.

Hence, a need exists in the art for a data arbitrator that can efficiently accommodate varying rates and burst and/or runtime-staggered data and that does not require restrictive data timing or scheduling.

### SUMMARY OF THE INVENTION

The need in the art is addressed by the system for selectively affecting data flow to and/or from a memory device of the present invention. In the illustrative embodiment, the inventive system is adapted for use with Synchronous Dynamic Random Access Memory (SDRAM) or an Enhanced SDRAM (ESDRAM) memory devices and associated data arbitrators. The system includes a first mechanism for intercepting data bound for the memory device or originating from the memory device. A second mechanism compares data level(s) associated with the first mechanism to one or more thresholds (which may include variable thresholds that may be changed in real time) and provides a signal in response thereto. A third mechanism releases data from the first mechanism or the memory device in response to the signal.

In a more specific embodiment, the system further includes a processor in communication with the first mechanism, which includes one or more memory buffers. The third mechanism releases data from the first mechanism to the processor and/or transfers data between the memory device and the first mechanism in response to the signal.

In the specific embodiment, the one or more memory buffers are register files or First-In-First-Out (FIFO) memory buffers. The second mechanism includes a level indicator that measures levels of the one or more FIFO memory buffers and provides level information in response thereto. The third mechanism includes a memory manager that provides the signal to the one or more FIFO buffers based on the level information, thereby causing the one or more FIFO buffers to release the data. The first mechanism includes one or more FIFO read buffers for collecting read data output from the memory device and selectively forwarding more read data from the memory device in response to the signal. The first mechanism also includes one or more FIFO write buffers for collecting write data from the processor and selectively forwarding the write data to the memory device in response to the signal.

The second mechanism determines when a write data level associated with the first mechanism reaches or surpasses one or more write data level thresholds and provides the signal in response thereto. The second mechanism also determines when the read data level associated with the first mechanism reaches or falls below one or more read data level thresholds and provides the signal in response thereto.

In a more specific embodiment, the memory device is a Synchronous Dynamic Random Access Memory (SDRAM) or an Enhanced SDRAM (ESDRAM). The one or more of the FIFO read buffers and/or FIFO write buffers are dual ported block Random Access Memories (RAM's).

The novel designs of embodiments of the present invention are facilitated by use of the read buffers and write buffers, which are data level driven. The buffers provide an efficient memory data interface, which is particularly advantageous when the memory and associated processor accessing the memory operate at different speeds. Furthermore, unlike conventional data arbitrators, use of buffers according to an embodiment of the present invention may enable the addition or removal of data path pipeline delays in the system without requiring re-design of the accompanying data arbitrator.

### BRIEF DESCRIPTION OF THE DRAWINGS

FIG. 1 is a block diagram of a computer system employing a memory data arbitrator according to an embodiment of the present invention.

FIG. 2 is a more detailed diagram of an illustrative embodiment of the computer system of FIG. 1.

FIG. 3 is a diagram illustrating an exemplary operating scenario for the computer systems of FIGS. 1 and 2.

FIG. 4 is a flow diagram of a method adapted for use with the operating scenario of FIG. 3.

FIG. 5 is a flow diagram of a method according to an embodiment of the present invention.

FIG. 6a is a block diagram of a computer system according to an embodiment of the present invention with equivalent numbers of memories and FIFO's.

FIG. 6b is a process flow diagram illustrating an overall process with various sub-processes employed by the system of FIG. 6a.

FIG. 7a is a block diagram of a computer system according to an embodiment of the present invention with fewer memories than FIFO's.

FIG. 7b is a process flow diagram illustrating an overall process with various sub-processes employed by the system of FIG. 7a.

### DESCRIPTION OF THE INVENTION

While the present invention is described herein with reference to illustrative embodiments for particular applications, it should be understood that the invention is not limited thereto. Those having ordinary skill in the art and access to the teachings provided herein will recognize additional modifications, applications, and embodiments within the scope thereof and additional fields in which the present invention would be of significant utility.

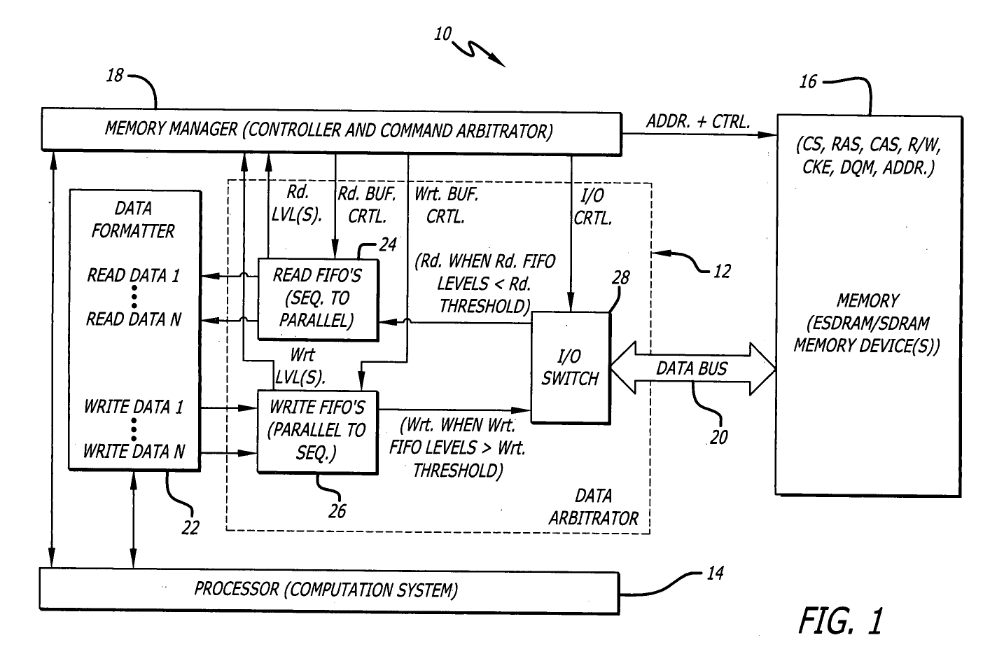

FIG. 1 is a block diagram of a computer system 10 employing a memory data arbitrator 12 according to an embodiment of the present invention. For clarity, various features, such as, power supplies, clocking circuitry, and soon, have been omitted from the figures. However, those skilled in the art with access to the present teachings will know which components and features to implement and how to implement them to meet the needs of a given application.

The computer system 10 includes a processor 14 in communication with the data arbitrator 12 and a memory manager 18. The processor 14 selectively provides data to and from the data arbitrator 12 and selectively provides memory commands to the memory manager 18. The memory manager 18 also communicates with the data arbitrator 12 and a memory 16. The memory 16 communicates with the data arbitrator 12 via a memory bus 20.

The data arbitrator 12 includes a data formatter 22 that interfaces the processor 14 with a set of read First-In-First-Out buffers (FIFO's) 24 and a set of write FIFO's 26. The data formatter 22 facilitates data flow control between the FIFO's 24, 26 and the processor 14. The data formatter 22 receives data input from the read FIFO's 24 and provides formatted data originating from the processor 14 to the write FIFO's 26. The data formatter 22 may be implemented in the processor 14 or omitted without departing from the scope of the present invention.

The FIFO buffers 24, 26 may be implemented as dual ported memories, register files, or other memory types without departing from the scope of the present invention. Furthermore, the memory device 16 may be an SDRAM, an Enhanced SDRAM (ESDRAM), Virtual Channel Memory (VCM), Synchronous Static Random Access Memory (SSRAM), or other memory type.

The read FIFO's 24 receive control input (Rd. Buff. Ctrl.) from the memory manager 18 and provide read FIFO buffer level information (Rd. Level) to the memory manager 18. The control input (Rd. Buff Ctrl.) from the memory manager 18 to the read FIFO's 24 includes control signals for both read and write operations.

Similarly, the write FIFO's 26 receive control input (Wrt. Buff. Ctrl.) from the memory manager 18 and provide write FIFO buffer level information (Wrt. Lvl.) to the memory manager 18. The write buffer control input (Wrt. Buff. Ctrl.) to the write FIFO's 26 include control signals for both read and write operations.

The read FIFO's 24 receive serial input from an Input/Output (I/O) switch 28 and selectively provide parallel data outputs to the data formatter 22 in response to control signaling from the memory manager 18. The read FIFO's 24 include a read FIFO bus, as discussed more fully below, that facilitates converting serial input data into parallel output data. Similarly, the write FIFO's 26 receive parallel input data from the data formatter 22 and selectively provide serial output data to the I/O switch 28 in response to control signaling from the memory manager 18. The I/O switch 28 receives control input (I/O Ctrl.) from the memory manager 18 and interfaces the read FIFO's 24 and the write FIFO's 26 to the memory bus 20.

In operation, computations performed by processor 14 may require access to the memory 16. For example, the processor 14 may need to read data from the memory 16 or write data to the memory 16 to complete a certain computation or algorithm. When the processor 14 must write data to the memory 16, the processor 14 sends a corresponding data write request (command) to the memory manager 18.

The memory manager 18 then controls the data arbitrator 12 and the memory 16 and communicates with the processor 14 as needed to implement the requested data transfer from the processor 14 to the memory 16 via the data formatter 22, the write FIFO's 26, the I/O switch 28, and the data bus 20. To prevent data overflow to the memory 16, the write FIFO's 26 act to catch data from the processor 14 and evenly disseminate the data at a desired rate to the memory 16. For example, without the write FIFO's 26, a large data burst from the processor 14, could cause data bandwidth overflow of the memory 16, which may be operating at a different speed than the processor 14.

Conventionally, complex and restrictive data scheduling schemes were employed to prevent such data overflow. Unlike conventional data scheduling approaches, the write FIFO's 26, which are data-level driven, may efficiently accommodate delays or other downstream timing changes.

As is well known in the art, a FIFO buffer is analogous to a queue, wherein the first item in the queue is the first item out of the queue. Similarly, the first data in the FIFO buffers 24, 26 are the first data output from the FIFO buffers 24, 26. Those skilled in the art will appreciate that buffers other than conventional FIFO buffers may be employed without departing from the scope of the present invention. For example, the FIFO buffers 24, 26 may be replaced with register files.

The memory manager 18 monitors data levels in the write FIFO's 26. FIFO data levels are analogous to the length of the queue. If data levels in the write FIFO's 26 surpass one or more write FIFO buffer thresholds, data from those FIFO's is then transferred to the memory 16 via the I/O switch 28 and data bus 20 at a desired rate, which is based on the speed of the memory 16. The amount of data transferred from the write FIFO's 26 in response to surpassing of the data threshold may be all of the data in those FIFO's or sufficient data to lower the data levels below the thresholds by desired amounts. The exact amount of data transferred may depend on the memory data-burst format.

The memory manager 18 may run algorithms to adjust the FIFO buffer thresholds in real time or as needed to meet changing operating conditions to optimize system performance. Those skilled in the art with access to the present teachings may readily implement real time changeable thresholds without undo experimentation.

Data may remain in the write FIFO's 26 until data levels of the FIFO's 26 pass corresponding thresholds. Alternatively, available data is constantly withdrawn from the write FIFO's 26 at a slower rate, and a faster transfer rate is applied to those FIFO's having data levels that exceed the corresponding thresholds. The faster data rate is chosen to bring the data levels back below the thresholds. Hence, the write FIFO's 26 are data-level driven.

Using more than one data rate may prevent data from getting stuck in the FIFO's 26. Alternatively, the memory manager 18 may run an algorithm to selectively flush the write FIFO's 26 to prevent data from being caught therein. Alternatively, the FIFO buffer thresholds may be dynamically adjusted by the memory manager 18 in accordance with a predetermined algorithm to accommodate changing processing environments. Those skilled in the art with access to the present teachings will know how to implement such an algorithm without undue experimentation.

When the processor 14 must read data from the memory 16, the processor 14 sends corresponding memory commands, which include any requisite data address information, to the memory manager 18. The memory manager 18 then selectively controls the data arbitrator 12 and the memory 16 to facilitate transfer of the data corresponding to the memory commands from the memory 16 to the processor 14.

The memory manager 18 monitors levels of the read FIFO's 24 to determine when one or more of the read FIFO's 24 have data levels that are below corresponding read FIFO buffer thresholds. Data is first transferred from the memory 16 through the I/O switch 28 to the read FIFO's having sub-threshold data levels. As the processor 14 retrieves data from the read FIFO's 24, the memory manager 18 ensures that read FIFO's 24 are filled with data as data levels become low, i.e., as they fall below the corresponding read FIFO buffer thresholds. The FIFO buffers 24, 26 provide an efficient memory data interface, also called data arbitrator, which facilitates memory sharing between plural video functions.

In some implementations, the read FIFO's 24 may facilitate accommodating data bursts from the memory 16 so that the processor 14 does not receive more data than it can handle at a particular time.

Like the write FIFO's 26, the data-level-driven read FIFO's 24 may facilitate interfacing the memory 16 to the processor 14, which may operate at a different speed or clock rate than the memory 16. In many applications, the memory 16 and the processor 14 run at different speeds, with memory 16 often running at higher speeds. The write FIFO's 26 and the read FIFO's 24 accommodate these speed differences.

Hence, the read FIFO's 24 are small FIFO buffers that act as sequential-to-parallel buffers in the present specific embodiment. Similarly, the write FIFO's 26 are small FIFO buffers that act as parallel-to-sequential buffers. These buffers 24, 26 accommodate timing discontinuity, data rate differences, and so on. Consequently, the data arbitrator 12 does not require scheduled timing, but is data-level driven.

Those skilled in the art will appreciate that in some implementations, the read FIFO's 24 and/or the write FIFO's 26 may be implemented as single FIFO buffers rather than plural FIFO buffers. The FIFO's 24, 26 may not necessarily act as sequential-to-parallel or parallel-to-sequential buffers.

One or more of the FIFO's 24 reading from memory 16 are serviced when data levels in those FIFO's 24 are below a certain threshold(s). One or more of the FIFO's 26 writing to the memory 16 are serviced when data levels in those FIFO's 26 are above a certain threshold (s).

The memory manager 18 may include various well-known modules, such as a command arbitrator, a memory controller, and so on, to facilitate handling memory requests. Those skilled in the art with access to the present teachings will know how to implement or otherwise obtain a memory manager to meet the needs of a given embodiment or implementation of the present invention.

Furthermore, various modules employed to implement the system 10, such as FIFO buffers with level indicator outputs incorporated therein, are widely available. Various components needed to implement various embodiments of the present invention may be ordered from Raytheon Co.

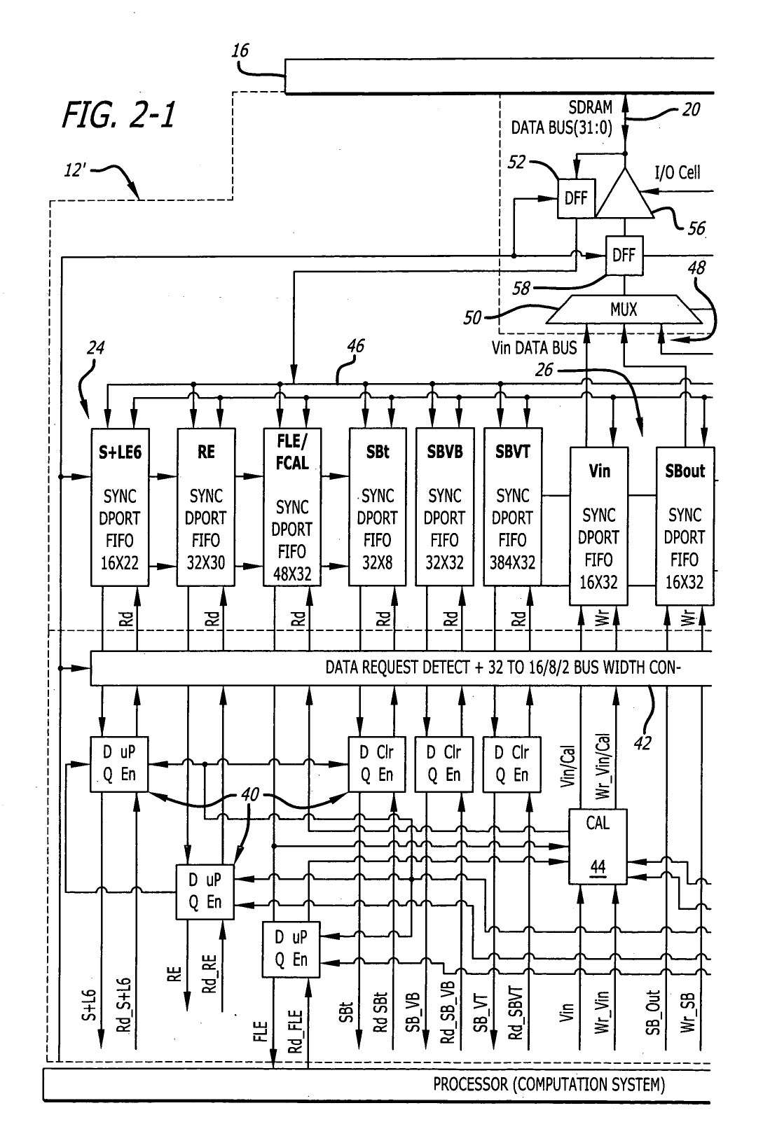

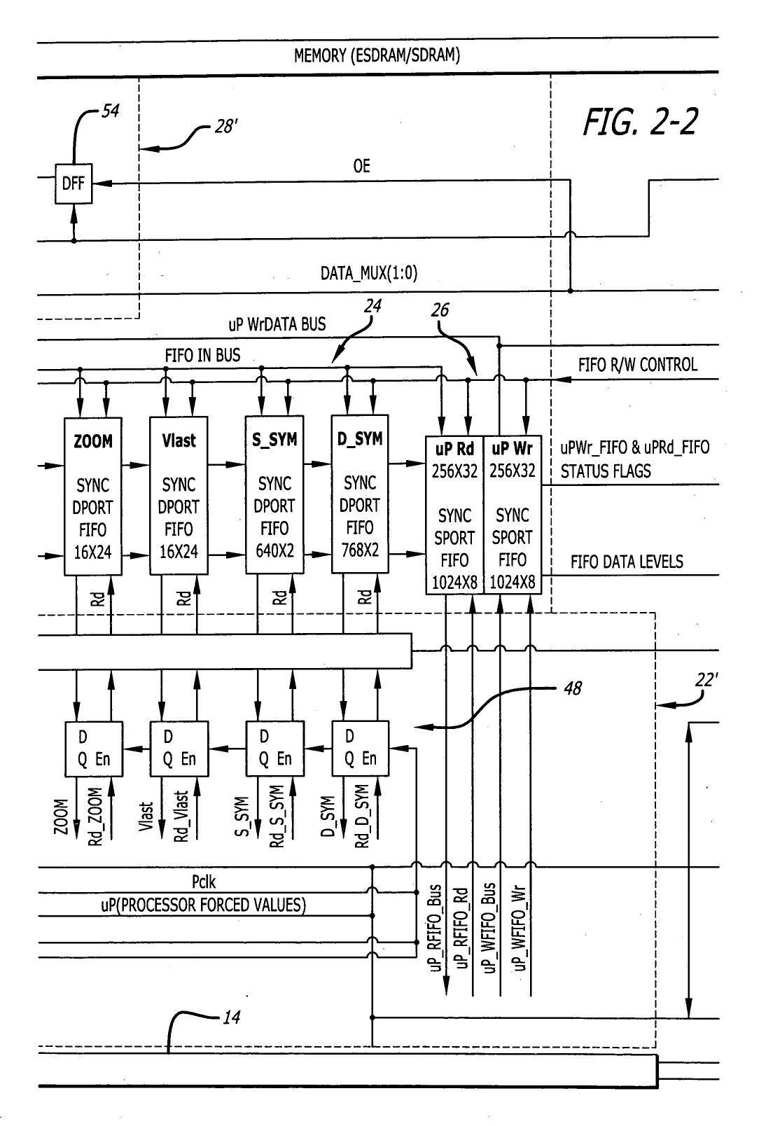

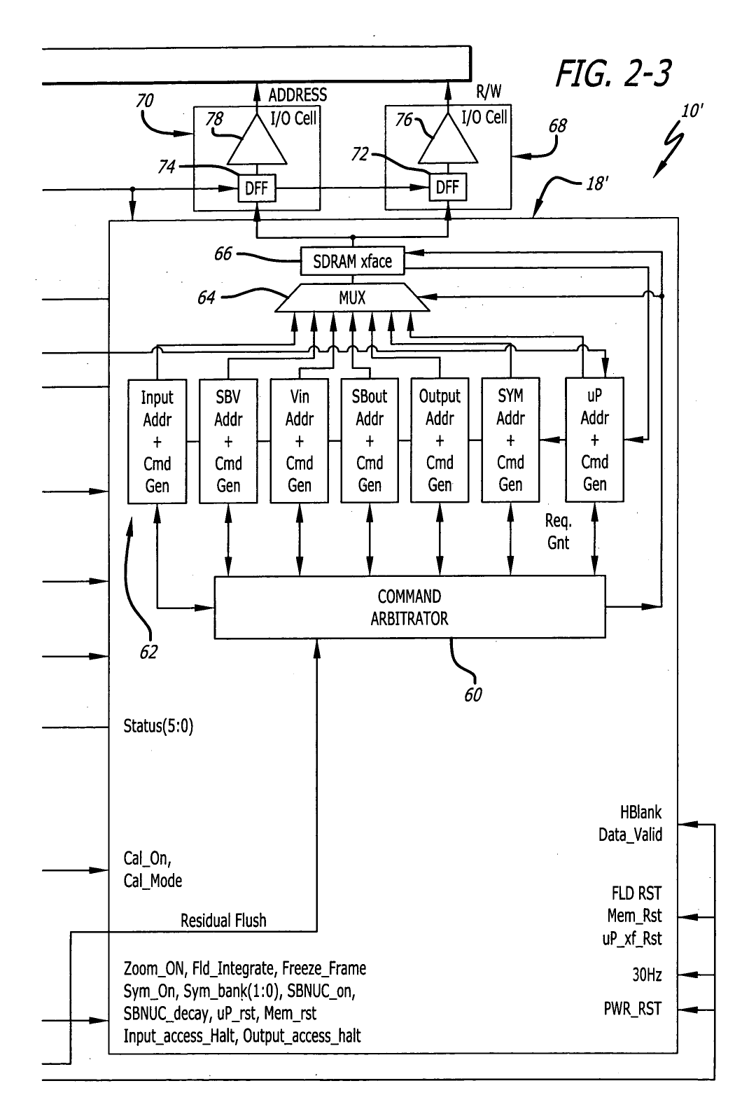

FIG. 2 is a more detailed diagram of an illustrative embodiment 10′ of the computer system 10 of FIG. 1. The system 10′ includes various modules 12′-28′ corresponding to the modules and components 12-28 of the system 10 of FIG. 1. In particular, the system 10′ includes the processor 14, a data arbitrator 12′, the memory 16, a memory manager 18′, the data bus 20, a data formatter 22′, read FIFO buffers 24′, write FIFO buffers 26, and I/O switch 28′. The modules of the system 10′ are interconnected similarly to the corresponding modules of the system 10 FIG. 1 with the exception that the data formatter 22′ also communicates with the memory manager 18′ to facilitate system calibration and to notify the memory manager 18′ of which data is being selected for transfer between the system 14 and the data arbitrator 12′. The operation of the system 10′ is similar to the operation of the system 10 of FIG. 1.

The data formatter 22′ includes various Registers 40 that are application-specific and serve to facilitate data flow control. The registers 40 interface the processor 14 with a data request detect and data width conversion mechanism 42, which interfaces the registers 40 to the FIFO's 24 and 26. An application-specific calibration module 44 included in the data formatter 22′ communicates with the processor 14 and the data request detect and data width conversion mechanism 42 and enable specific calibration data to be transferred to and from the memory 16 to perform calibration as need for a particular application.

The data arbitrator 12′ includes a FIFO read bus 46 that interfaces the read FIFO's 24 to the I/O switch 28′. Plural write FIFO busses 48 and a multiplexer (MUX) 50 interface the write FIFO's 26 with the I/O switch 28′. The MUX 50 receives control input from the memory manager 18′.

The I/O switch 28′ includes a first D Flip-Flop (DFF) 52 that interfaces the memory data bus 20 with the read FIFO bus 46. A second DFF 54 interfaces a data MUX control signal (I/O control) from the memory manager 18′ to an I/O buffer/amplifier 56. A third DFF 58 in the I/O switch 28′ interfaces the MUX 50 to the I/O buffer/amplifier 56.

The first DFF 52 and the first DFF 58 act as registers (sets of flip-flops) that facilitate bus interfacing. The second DFF 54 may be a single flip-flop, since it controls the bus direction through the I/O switch 28′.

The memory manager 18′ includes a command arbitrator 60 in communication with various command generators 62, which generate appropriate memory commands and address combinations in response to input received via the processor 14 and data arbitrator 12′. The command generator 62 interface the command arbitrator 60 to a second MUX 64, which controls command flow to a memory interface 66 in response to control signaling from the command arbitrator 60.

In the present embodiment, the memory 16 is a Dynamic Random Access Memory (SDRAM) or an Enhanced SDRAM (ESDRAM). The memory interface 66 selectively provides commands, such as read and write commands, to the memory (SDRAM) 16 via a first I/O cell 68 and provides corresponding address information to the memory 16 via a second I/O cell 70. The I/O cells 68, 70 include corresponding D Flip-Flops (DFF's) 72, 74 and buffer/amplifiers 76, 78. The processor 14 selectively controls various modules and buses, such as the data request detect and data width conversion mechanism 42 of the data formatter 22′, as needed to implement a given memory access operation.

In the present specific embodiment the FIFO's 24, 26 have sufficient data storage capacity to accommodate any system data path pipeline delays. The FIFO's 24, 26 include FIFO's for handling data path parameters; holding commands; and storing data for special read operations (uP Read) and write operations (uP Write).

In the present specific embodiment, the FIFO's for handling data path parameters (data path FIFO's connected to the data request detect and data width conversion mechanism 42) exhibit single-clock synchronous operation and are dual ported block RAM's. This obviates the need to use several configurable logic cells. The data-path FIFO's exhibit built-in bus-width conversion functionality. Furthermore, some data capturing registers are double buffered. The remaining uP Read and uP Write FIFO's are also implemented via block RAM's and exhibit dual clock synchronous operation with bus-width conversion functionality.

In the present specific embodiment, the memory interface 66 is an SDRAM/ESDRAM controller that employs an instruction decoder and a sequencer in a master-slave pipelined configuration as discussed more fully in co-pending U.S. patent application, Ser. No. 10/844,284, filed May 12, 2004 entitled EFFICIENT MEMORY CONTROLLER, Attorney Docket No. PD-03W077, which is assigned to the assignee of the present invention and incorporated by reference herein. The memory interface 66 is also discussed more fully in the above-incorporated provisional application, entitled CYCLE TIME IMPROVED ESDRAM/SDRAM CONTROLLER FOR FREQUENT CROSS-PAGE AND SEQUENTIAL ACCESS APPLICATIONS.

The operation of the FIFO's 24, 26 in the system 10′ is analogous to the operation of the FIFO's 24, 26 of FIG. 1. Data levels of the FIFO's 24, 26 cause/effect the behavior of the various command generators 62 of the memory manager 18 as illustrated in the following table:

TABLE 1

| Command | | FIFO | |
|---|---|---|---|
| Generator 62 | FIFO's | type | Comments |
| Input addr + | S + LE6, | Read | These FIFO's are grouped |
| cmd | RE, | FIFO's | together, using one FIFO full- |
| | FLE/F | 24 | ness flag (from leading S + LE6 |
| | CAL, | | FIFO) to trigger this command |
| | SBt | | generator to simplify design |
| | | | (because all FIFO's in group are |
| | | | within close timing proximity). |
| | | | Other FIFO's are of lager depth |
| | | | than the leading FIFO to com- |
| | | | pensate for data path pipeline. |
| | | | This command generator (Input |
| | | | addr + cmd) fills all associated |
| | | | FIFO's with same amount of |
| | | | data when triggered. |
| SBV addr + | SBVB, | Read | Independent FIFO's each pro- |
| cmd | SBVT | FIFO's | vide their own FIFO fullness |
| | | 24 | flag to this command generator. |
| Vin addr + | Vin | Write | This command generator (SBV |
| cmd | | FIFO 26 | addr + cmd) checks only for |
| | | | the Vin fullness flag. |
| SBout addr + | SBout | Write | |
| cmd | | FIFO 26 | |
| Output addr + | Zoom, | Read | Each associated FIFO provides |
| cmd | Vlast | FIFO's | its own fullness flag to this |
| | | 24 | command generator (Output |
| | | | addr + cmd). |
| Sym addr + | S_Sym, | Read | Each FIFO provides its own full- |
| cmd | D_Sym | FIFO's | ness flag to this command gener- |
| | | 24 | ator (Sym addr + cmd). |
| uP addr + | uP Rd, | Read | Independent FIFO types asso- |
| cmd | uP Wr | FIFO 24 | ciated with a single command |
| | | and Write | generator (uP addr + cmd). |
| | | FIFO 26 | |

The processor 14 provides a residual flush signal (Residual Flush) to the command arbitrator 60 to force write-to-memory-command generators 62 to selectively issue memory write commands even when write FIFO threshold(s) are not reached. In the present embodiment, residual flush signals are issued at the ends of data frames with data levels that are not exact multiples of the write FIFO threshold(s). This prevents any residual data from getting stuck in the write FIFO's 26 after such frames.

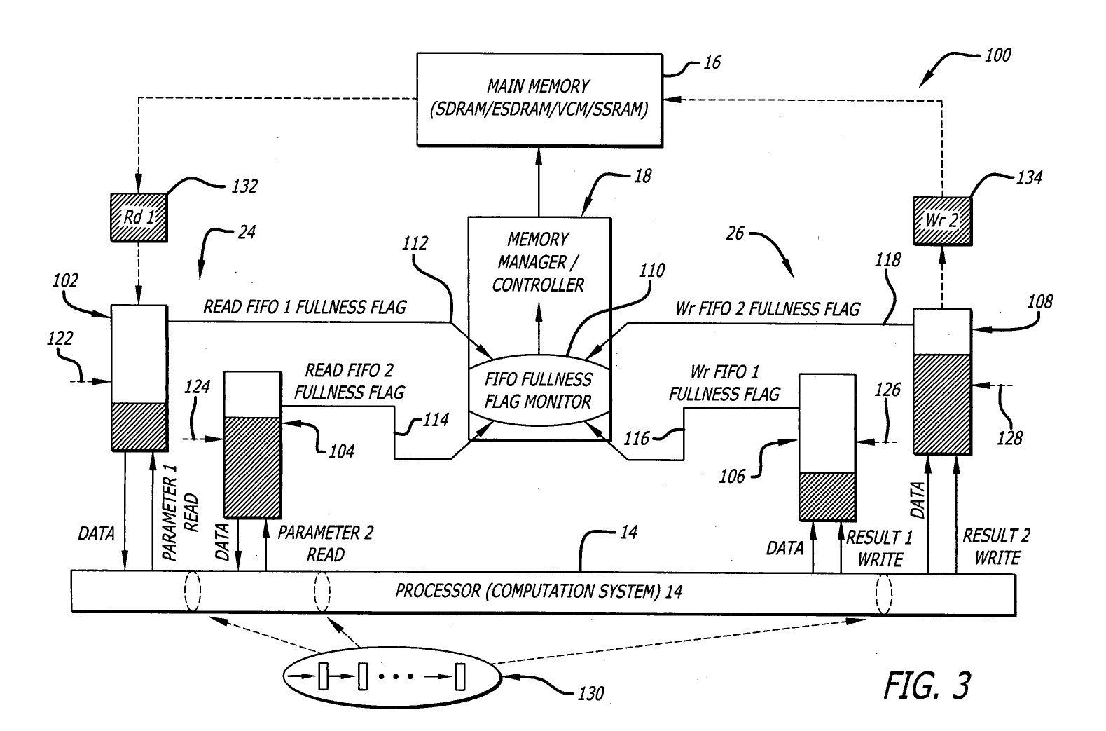

FIG. 3 is a diagram illustrating an exemplary operating scenario 100 applicable to the computer systems of FIGS. 1 and 2. With reference to FIG. 1 and 3, the scenario 100 involves a first read FIFO 102, a second read FIFO 104, a first write FIFO 106, and a second write FIFO 108. The FIFO's 102-108 communicate with the processor 14 and a FIFO fullness flag monitor 110 of the memory manager 18, which communicates with the main memory 16. The FIFO's 102-108 send corresponding fullness flags 112-118 to the FIFO fullness flag monitor 110 when corresponding thresholds 122-128 are passed.

Generally, when data levels in the read FIFO's 102 and/or 104 (24) pass below corresponding thresholds 122 and/or 124, corresponding fullness flags 112 and/or 114 are set, which trigger the memory manager 18 to release a burst of read FIFO data 132 from memory 16 to the those read FIFO's 102 and/or 104, respectively. Similarly, when data levels in the write FIFO's 106 and/or 108 surpass corresponding thresholds 126 and/or 128, corresponding fullness flags 116 and/or 118 are set, which trigger the memory manager 18 to transfer a burst of write FIFO data 134 from those write FIFO's 106 and/or 108 to the memory 16.

In the specific scenario 100, data levels in the first read FIFO buffer 102 have passed below the first read FIFO buffer threshold 122. Accordingly, the corresponding fullness flag 112 is set, which causes the memory manager 18 to release the burst of read FIFO data 132 from the memory 16 to the read FIFO 102. This brings the read data in the first read FIFO 102 past the threshold 122,which turns off the first read FIFO fullness flag 112.

Similarly, data levels in the second write FIFO 108 have passed the corresponding write FIFO threshold 128. Accordingly, the corresponding write FIFO fullness flag 118 is set, which causes the memory manager 18 to transfer the burst of write FIFO data 13 from the second write FIFO 108 to the memory 16.

Data transfers, including parameter reads and writes between the processor 14 and the FIFO's 102-108, are at the system clock rate, i.e., the clock rate of the processor 14. Data transfers between the FIFO's 102-108 and the memory 16 occur at the memory clock rate. Parameter read and write and memory read and write operations can occur simultaneously. The depths of the FIFO's 102-108 are at least as deep as the corresponding threshold level 122-128 plus the amount of data per data burst. Note that inserting or deleting various pipeline stages 130 does not constitute a change in the memory-timing scheme.

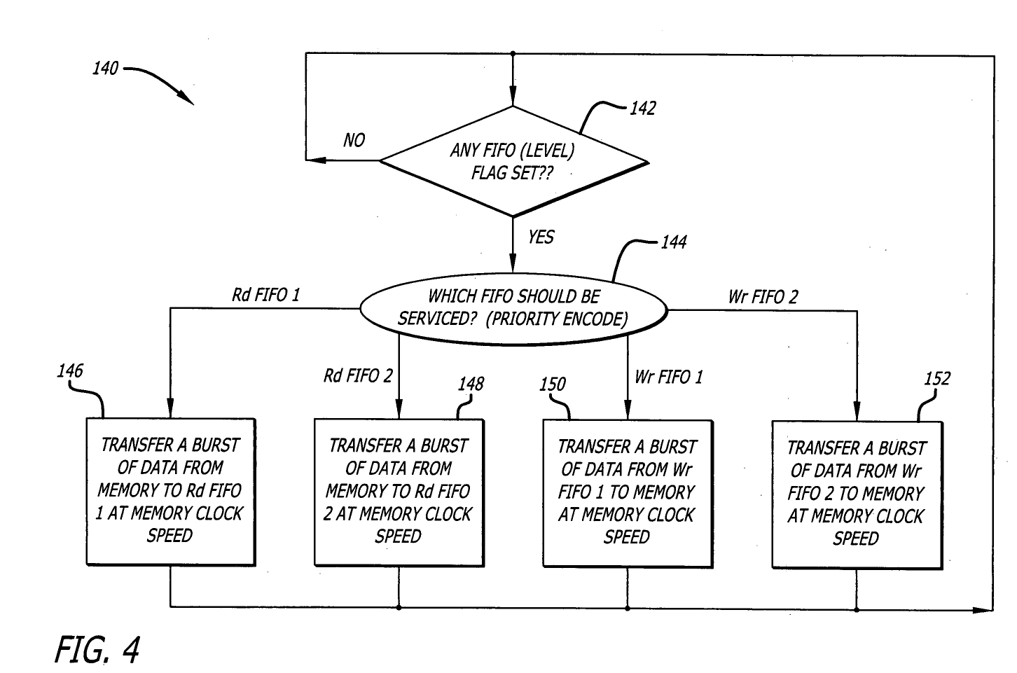

FIG. 4 is a flow diagram of a method 140 adapted for use with the operating scenario of FIG. 3. With reference to FIGS. 3 and 4, the method 140 holds until a FIFO flag 112-118 is set in a flag-determining step 142.

In a subsequent service-checking step 144, the fullness flag monitor 110 determines which of the FIFO's 102-108 should be serviced based on which fullness flag(s) 112-118 are set. If the first read FIFO fullness flag 112 is set, then a burst of data is transferred from the memory 16 at the memory clock rate in a first transfer step 146. If the second read FIFO fullness flag 114 is set, then a burst of data is transferred from the memory 16 at the memory clock rate in a second transfer step 148. If the first write FIFO fullness flag 116 is set, then a burst of data is transferred from the first write FIFO 106 to the memory 16 at the memory clock speed in a third transfer step 150. Similarly, if the second write FIFO fullness flag 118 is set, then a burst of data is transferred from the second write FIFO 108 to the memory 16 at the memory clock speed in a fourth transfer step 152.

After steps 146-152, control is passed back to the flag-determining step 142. The fullness flags 112-118 may be priority encoded to facilitate determining which FIFO should be serviced based on which flags have been triggered. The FIFO fullness flags 112-118 can be set simultaneously.

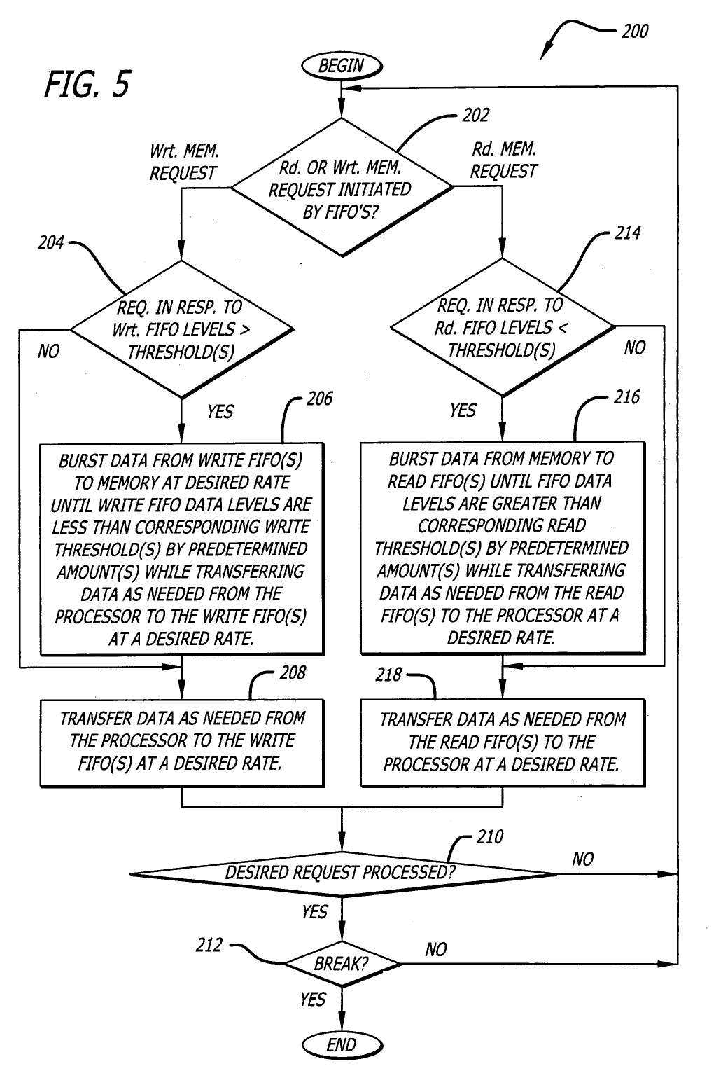

FIG. 5 is a flow diagram of a method 200 according to an embodiment of the present invention. With reference to FIGS. 1 and 5, in an initial request-determination step 202, the memory manager 18 determines whether a memory read command or a write command or both have been initiated by the read FIFO's 24 and/or the write FIFO's 26, respectively. FIFO data levels drive memory requests.

If a write command has been initiated, control is passed to a write FIFO level-determining step 204. If a read command has been initiated, control is passed to a read FIFO level-determining step 214. If both read and write commands have been initiated, then control is passed to both the write FIFO level-determining step 204 and the read FIFO level-determining step 214, respectively.

In the write FIFO level-determining step 204, the memory manager 18 monitors the levels of the write FIFO's 26 and determines when one or more of the levels passes a corresponding write FIFO threshold. If one or more of the write FIFO's 26 have data levels surpassing the corresponding threshold(s), then control is passed to a write FIFO-to-memory data transfer step 206. Otherwise, control is passed to a processor-to-write FIFO data transfer step 208. Those skilled in the art will appreciate that the FIFO level threshold comparison implemented in the FIFO level-determining step 204 may be another type of comparison, such as a greater-than-or-equal-to comparison, without departing from the scope of the present invention.

In the write FIFO-to-memory data transfer step 206, the memory manager 18 of FIG. 1 enables the write FIFO's 26 to burst data or otherwise evenly transfer data from the write FIFO's 26 with data levels exceeding corresponding thresholds to the memory 16. The data is transferred from the write FIFO's 26 to the memory 16 at a desired rate (memory clock rate) until the corresponding data levels recede below the thresholds by desired amounts. Note that simultaneously, data may be transferred as needed from the processor 14 to the write FIFO's 26 at a desired rate while the write FIFO's 26 burst data to the memory. Subsequently, control is passed to the processor-to-write FIFO data transfer step 208. In some implementations, a single data burst may be sufficient to cause the data levels in the write FIFO's 26 to pass back below the corresponding thresholds by the desired amount.

In the processor-to-write FIFO data transfer step 208 data corresponding to pending memory requests, i.e., commands, is transferred from the processor 14 to the write FIFO's 26 as needed and at a desired rate. The rate of data transfer from the system 14 to the write FIFO's 26 at any given time is often different than the rate of data transfer from the write FIFO's 26 to the memory 16. However, the average transfer rates over long periods may be equivalent. Subsequently, control is passed to an optional request-checking step 210.

In the optional request-checking step 210, the memory manager 18 and/or processor 14 determine(s) if the desired memory request has been serviced. If the desired memory request has been serviced, and a break occurs (system is turned off) in a subsequent breaking step 212, then the method 200 completes. Otherwise, control is passed back to the initial request-determination step 202.

If in the initial request-determination step 202, the memory manager 18 determines that read memory requests are pending, then control is passed to the read FIFO level-determining step 214. In the read FIFO level-determining step 214, the memory manager 18 determines if one or more of the data levels of the read FIFO's 24 are below corresponding read FIFO thresholds. If data levels are below the corresponding thresholds, then control is passed to a memory-to-read FIFO data transfer step 216. Otherwise, control is passed to a read FIFO-to-processor data transfer step 218. Those skilled in the art will appreciate that the FIFO level threshold comparison implemented in step 214 may be another type of comparison, such as a less-than-or-equal-to comparison, without departing from the scope of the present invention.

In the memory-to-read FIFO data transfer step 216, the memory manager 18 facilitates bursting data or otherwise evenly transferring data from the memory 16 to the read FIFO's 24 until data levels in those read FIFO's 24 surpass corresponding thresholds by desired amounts or until data transfer from the memory 16 for a particular request is complete. Note that simultaneously, data may be transferred as needed from the read FIFO's 24 to the processor 14 at the desired rate as the memory 16 bursts data to the read FIFO's 24. Subsequently, control is passed to the read FIFO-to-processor data transfer step 218.

In the read FIFO-to-processor data transfer step 218, the memory manager 18 facilitates data transfer as needed from the read FIFO's 24 to the processor 14 at a predetermined rate, which may be different from the rate of data transfer between the read FIFO's 24 and the memory 16. Note that in some implementations, steps 208 and 218 may prevent data from getting stuck in FIFO's 24, 26 near the completion of certain requests, such as when the write FIFO data levels are less than the associated write FIFO threshold(s) or when the read FIFO data levels are greater than the associated read FIFO threshold(s). Subsequently, control is passed to the request-checking step 210, where the method returns to the original step 202 if the desired data request had not yet been serviced.

Note that both sides of the method 200, which begin at steps 204 and 214, may operate simultaneously and independently. For example, the left side, represented by steps 204-208 may be at any stage of completion while the right side, represented by steps 214-218, is at any stage of completion. Furthermore, steps 206 and 208 may operate in parallel and simultaneously and may occur as part of the same step without departing from the scope of the present invention. For example, functions of step 208 may occur within step 206. Similarly, steps 216 and 218 may operate in parallel and simultaneously and may occur as part of the same step. Furthermore, those skilled in the art will appreciate that within various steps, including steps 206 and 216, other processes may occur simultaneously. Furthermore, several instances of the method 200 may run in parallel without departing from the scope of the present invention.

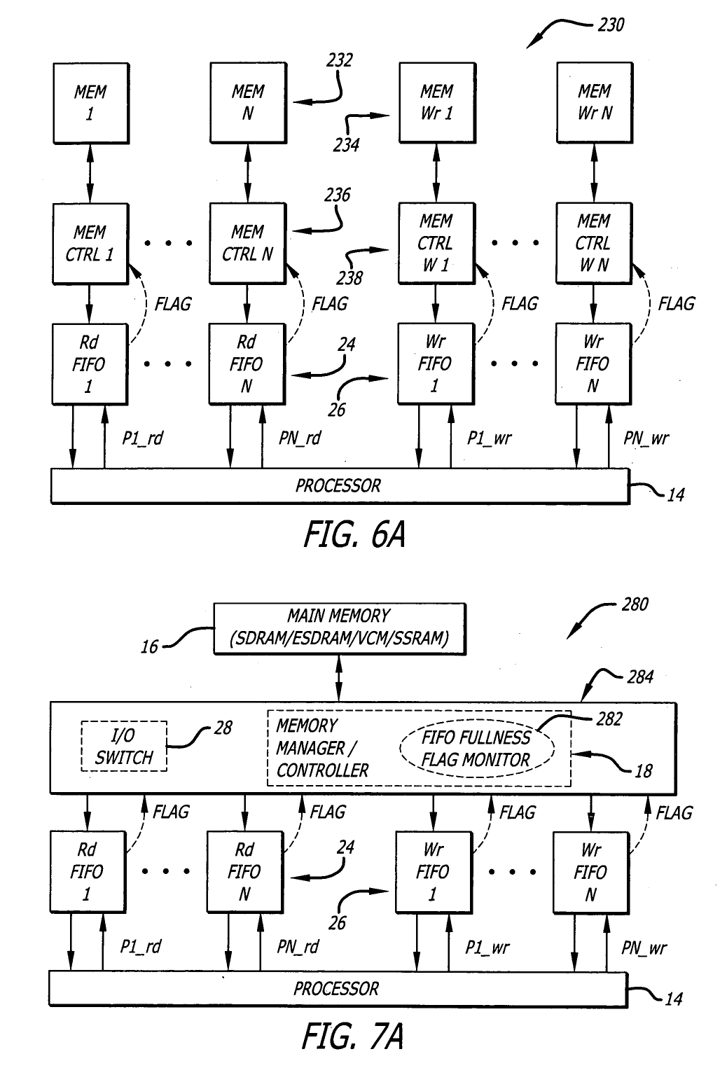

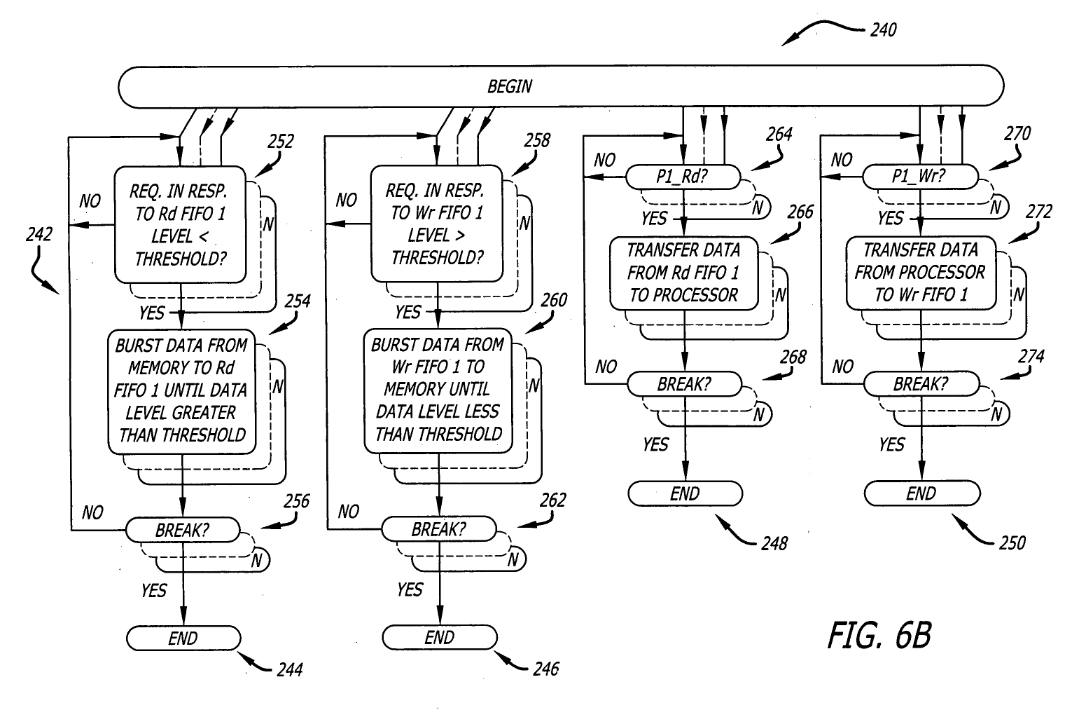

FIG. 6a is a block diagram of a computer system 230 according to an embodiment of the present invention. The computer system 230 has equivalent numbers of memories 232, 234 and FIFO's 24, 26. The computer system 230 includes N read memories (read memory blocks) and N write memories (write memory blocks) 234. Each of the N read memories 232 communicates with N corresponding read memory controllers 236. Each of the N read memory controllers 236 communicate with corresponding read FIFO's 24 to facilitate interfacing with the processor 14. Similarly, each of the N write memories 234 communicates with N corresponding write memory controllers 238. Each of the N write memory controllers 238 communicate with corresponding write FIFO's 26 to facilitate interfacing with the processor 14.

Operations between each of the FIFO's 24, 26 and the processor 14 are called processor-to/from-FIFO processes. The processor-to/from-FIFO processes are independent and can happen simultaneously as discussed more fully below. The processor-to/from-FIFO processes include data transfers from the read FIFO's 24 to the processor 14 in response to parameter-read commands (P1_rd . . . PN_rd), which are issued by the processor 14 to the read FIFO's 24. The processor-to/from-FIFO processes also include data transfers from the processor 14 to the write FIFO's 26 when parameter-write commands (P1_wr . . . PN_wr) are issued by the processor 14 to the write FIFO's 26.

Operations between each of the memories 232, 234 and the corresponding FIFO's 24, 26 via the corresponding memory controllers 236, 238 are called memory-to/from-FIFO processes. The memory-to/from-FIFO processes are independent and can happen simultaneously, as discussed more fully below. The memory-to/from-FIFO processes include data bursts from the read memories 232 to read FIFO's 24 in response to read FIFO data levels passing below specific read FIFO thresholds as indicated by read FIFO fullness flags forwarded to the corresponding read memory controllers 236. The memory-to/from-FIFO processes also include data transfers from the write FIFO's 26 to the write memories 234 when data levels in the write FIFO's 26 exceed specific write FIFO thresholds as indicated by write FIFO fullness flags, which are forwarded to the corresponding write memory controllers 238.

FIG. 6b is a process flow diagram illustrating an overall process 240 with various sub-processes 242 employed by the system 230 of FIG. 6a. With reference to FIGS. 6a and 6b, the system 230 initially starts plural simultaneous sub-processes 242, which include a first set of parallel sub-processes 244, a second set of parallel sub-processes 246, a third set of parallel sub-processes 248, and a fourth set of sub-processes 250. The first set of parallel sub-processes 244 and the second set of parallel sub-processes 246 are memory-to/from-FIFO processes. The third set of parallel sub-processes 248 and the fourth set of sub-processes 250 are processor-to/from-FIFO processes.

In the first set of sub-processes 244 the read memory controllers 236 monitor read FIFO fullness flags from corresponding read FIFO's 24 in first threshold-checking steps 252. The first threshold-checking steps 252 continue checking the read FIFO fullness flags until one or more of the read FIFO fullness flags indicate that associated read FIFO data levels are below specific read FIFO thresholds. In such case, one or more of the processes of the first set of parallel sub-processes 24 that are associated with read FIFO's whose data levels are below specific read thresholds proceed to corresponding read-bursting steps 254.

In the read-bursting steps 254, controllers 236 corresponding to read FIFO's with triggered fullness flags initiate data bursts from the corresponding memories 232 to the corresponding read FIFO's 24 until corresponding read FIFO data levels surpass corresponding read FIFO thresholds. After bursting data from appropriate memories 232 to appropriate read FIFO's 24, the sub-processes of the first set of parallel sub-processes 244 having completed steps 254 then proceed back to the initial threshold-checking steps 252, unless breaks are detected in first break-checking steps 256. Sub-processes 244 experiencing system-break commands end.

In the second set of sub-processes 246, the write memory controllers 238 monitor write FIFO fullness flags from corresponding write FIFO's 26 in second threshold-checking steps 258. Sub-processes associated with write FIFO's 26 having data levels that exceed corresponding FIFO thresholds continue to write-bursting steps 260.

In the write-bursting steps 260, write memory controllers 238 associated with write FIFO's with data levels exceeding corresponding write FIFO thresholds (triggered write FIFO's) by predetermined amounts initiate data bursting from the triggered write FIFO's 238 to the corresponding memories 234. Data bursting occurs until data levels in those triggered write FIFO's 238 become less than corresponding write FIFO thresholds by predetermined amounts.

After the one or more of the parallel sub-processes 246 complete associated write-bursting steps 260, the sub-processes 246 return to the second threshold-checking steps 258, unless breaks are detected in second break-checking steps 262. Sub-processes 246 experiencing system-break commands end.

In the third set of sub-processes 248, the read FIFO's 24 monitor parameter-read commands from the processor 14 in read parameter monitoring steps 264. When one or more parameter-read commands are received by one or more corresponding read FIFO's 24, then corresponding read data transfer steps 266 are activated.

In the read data transfer steps 266, data is transferred from the read FIFO's 236, which received parameter-read commands from the processor 14, to the processor 14, as specified by the parameter read commands. Subsequently, control is passed back to the read parameter monitoring steps 264 unless system breaks are determined in third break-checking steps 268. Sub-processes 248 experiencing system-break commands end.

In the fourth sub-processes 250, the write FIFO's 26 monitor parameter-write commands from the processor 14 in write parameter monitoring steps 270. When one or more parameter-write commands are received by one or more corresponding write FIFO's 26, then corresponding write data transfer steps 272 are activated.

In the write data transfer steps 272, data is transferred from the processor 14 to the write FIFO's 26 as specified by the parameter-write commands. Subsequently, control is passed back to the write parameter monitoring steps 270 unless system breaks are determined in fourth break-checking steps 274. Sub-processes 250 experiencing system-break commands end.

Hence, the computer system 230, which employs the overall process 240, strategically employs the FIFO's 24, 26 to optimize data transfer between the processor 14 and multiple memories 232, 234.

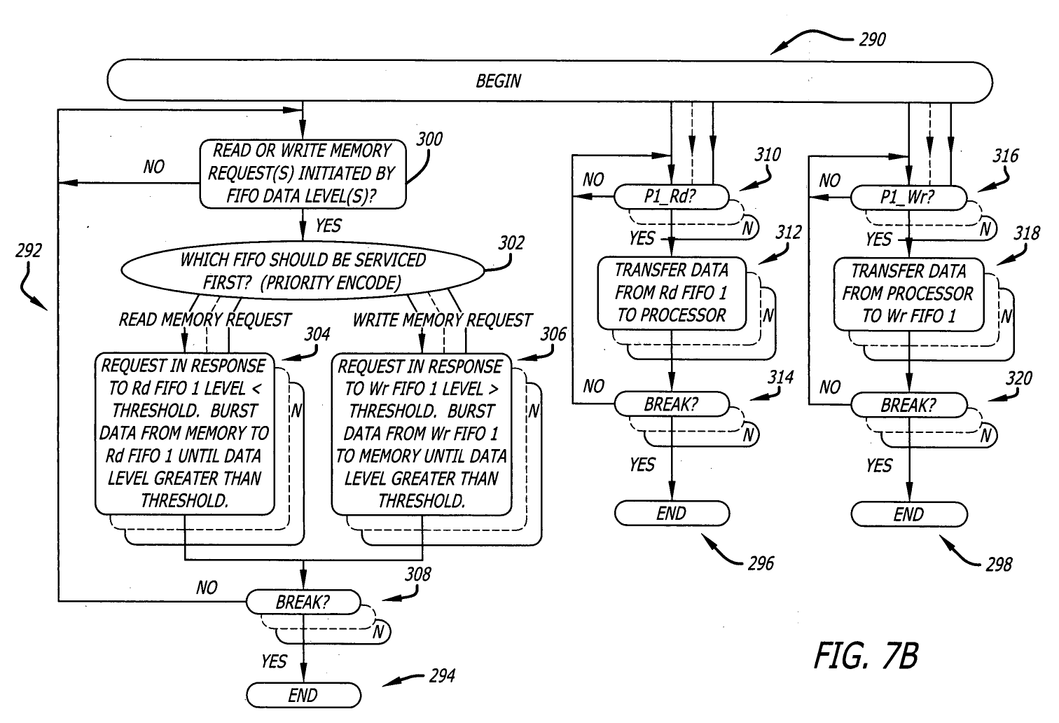

FIG. 7a is a block diagram of a computer system 280 according to an embodiment of the present invention with fewer memories (one memory 16) than FIFO's 24, 26. The system 280 is similar to the system 10 of FIG. 1 with the exception that the data formatter 22 of FIG. 1 is not shown in FIG. 7a or is incorporated within the processor 14 in FIG. 7a. Furthermore, the I/O switch 28, memory manager/controller 18 and accompanying FIFO fullness flag monitor 282 are shown as part of a memory-to-FIFO interface 284.

The read FIFO's 24 and the write FIFO's 26 provide fullness flags or other data-level indications to the memory-to-FIFO interface 284. The read FIFO's 24 receive data that is burst from the memory 16 to the read FIFO's 24 when their respective read FIFO data levels are below corresponding read FIFO thresholds as indicated by corresponding read FIFO fullness flags. The read FIFO's 24 forward data to the processor 14 in response to receipt of parameter-read commands.

Similarly, the write FIFO's 26 receive data from the processor 14 after receipt of parameter-write commands from the processor 14. Data is burst from the write FIFO's 26 to the memory 16 via the memory-to-FIFO interface 284 in when data levels of the write FIFO's 26 exceed specific write FIFO thresholds as indicated by write FIFO fullness flags.

FIG. 7b is a process flow diagram illustrating an overall process 290 with various parallel sub-processes 292 employed by the system 280 of FIG. 7a. The parallel sub-processes 292 include a first set of memory-to/from-FIFO processes 294, a second set of processor-from-FIFO sub-processes 296, and a third set of processor-to-FIFO sub-processes 298.

With reference to FIGS. 7a and 7b, the overall process 290 launches the sub-processes 294-298 simultaneously. The first set of memory-to/from-FIFO processes 294 begins at a request-determining step 300. In the request-determining step 300, the memory manager/controller 18 and accompanying fullness flag monitor 282 of the memory-to-FIFO interface 284 are employed to determine when one or more read or write memory requests are initiated in response to FIFO data levels based on FIFO fullness flags. If no memory requests are generated, as determined via the request-determining step 300, then the step 300 continues checking for memory requests initiated by FIFO fullness flags until one or more requests occur.

When one or more requests occur, control is passed to a priority-encoding step 302, where the memory manager/controller 18 determines which request should be processed first in accordance with a predetermined priority-encoding algorithm. Those skilled in the art will appreciate that various priority-encoding algorithms, including priority-encoding algorithms known in the art, may be employed to implement the process 290 without undue experimentation.

For read memory requests, control is passed to read-bursting steps 304, where data is burst from the memory 16 to the flagged read FIFO's 24, which are FIFO's 24 with data levels that are less than corresponding read FIFO thresholds by predetermined amounts. Data bursting continues until the data levels in the flagged read FIFO's 24 reach or surpass the corresponding read FIFO thresholds by predetermined amounts. In this case, control is passed back to the request-determining step 300 unless one or more breaks are detected in first break-determining steps 308. Sub-processes 294 experiencing system-break commands end.

For write memory requests, control is passed to write-bursting steps 306, where data is burst from flagged write FIFO's 26 to the memory 16. Flagged write FIFO's 26 are FIFO's whose data levels exceed corresponding write FIFO thresholds by predetermined amounts. Data bursting continues until data levels in the flagged write FIFO's 26 fall below corresponding write FIFO thresholds by predetermined amounts. In this case, control is passed back to the request-determining step 300 unless one or more breaks are detected in first break-determining steps 308. Sub-processes 294 experiencing system-break commands end.

The second set of processor-from-FIFO sub-processes 296 begins at parameter-read steps 310. The parameter-read steps 310 involve the read FIFO's 24 monitoring the output of the processor 14 for parameter-read commands. When one or more parameter-read commands are detected by one or more corresponding read FIFO's 24 (activated read FIFO's 24), then corresponding processor-from-FIFO steps 312 begin.

In the processor-from-FIFO steps 312, data is transferred from the activated read FIFO's 24 to the processor 14 in accordance with the parameter-read commands. Subsequently, control is passed back to the parameter-read steps 310 unless one or more system breaks are detected in second break-determining steps 314. Sub-processes 296 experiencing system-break commands end.

The third set of processor-to-FIFO sub-processes 298 begins at parameter-write steps 316. The parameter-write steps 316 involve the write FIFO's 26 monitoring the output of the processor 14 for parameter-write commands. When one or more parameter-write commands are detected by one or more corresponding write FIFO's 26 (activated write FIFO's 26), then corresponding processor-to-FIFO steps 318 begin.

In the processor-to-FIFO steps 318, data is transferred from the processor to the activated write FIFO's 26 in accordance with the parameter-write commands. Subsequently, control is passed back tot he parameter-write steps 316 unless one or more system breaks are detected in third break-determining steps 320. Sub-processes 298 experiencing system-break commands end.

Hence, the computer system 280, which employs the overall process 290, strategically employs the FIFO's 24, 26 to optimize data transfer between the processor 14 and the memory 16.

Thus, the present invention has been described herein with reference to a particular embodiment for a particular application. Those having ordinary skill in the art and access to the present teachings will recognize additional modifications, applications, and embodiments within the scope thereof.

It is therefore intended by the appended claims to cover any and all such applications, modifications and embodiments within the scope of the present invention.

Accordingly,

1. A system for selectively affecting data flow to or from a memory device comprising:
first means for intercepting data bound for said memory device or originating from said memory device;
second means for comparing a data level associated with said first means to one or more thresholds and providing a first signal in response thereto; and
third means for selectively releasing data from said first means or said memory device in response to said first signal.

2. The system of claim 1 further including a processor in communication with said first means, and wherein said third means releases data from said first means to said memory device and/or transfers data between said memory device and said first means in response to said first signal.

3. The system of claim 1 wherein said first means includes one or more memory buffers.

4. The system of claim 3 wherein said first means further includes means for selectively flushing any residual data from said one or more memory buffers.

5. The system of claim 3 wherein said one or more memory buffers are register files, First-In-First-Out (FIFO) memory buffers, dual ported memories or a combination thereof.

6. The system of claim 3 wherein said one or more memory buffers include means for producing fullness flags when corresponding thresholds are passed.

7. The system of claim 6 wherein said corresponding thresholds are changeable in real time.

8. The system of claim 5 wherein said second means includes a level indicator that measures levels of said one or more memory buffers and provides level information in response thereto.

9. The system of claim 8 wherein said third means includes a memory manager, said memory manager providing a second signal (buffer control signal) to said one or more FIFO buffers based on said level information indicated by said first signal, thereby causing said one or more FIFO buffers to release data, or providing a third signal (memory control signal) to said memory device in response to said first signal, thereby causing said memory device to release data to said one or more FIFO buffers.

10. The system of claim 9 wherein said first means includes one or more FIFO read buffers for collecting read data output from said memory device in response to said third signal and selectively forwarding said read data to a processor, and wherein said first means includes one or more FIFO write buffers for collecting write data from said processor and selectively forwarding said write data to said memory device in response to said second signal.

11. The system of claim 10 wherein said second means includes means for determining when said write data level associated with said first means reaches or surpasses one or more write data level thresholds and providing said first signal in response thereto.

12. The system of claim 11 wherein said second means includes means for determining when said read data level associated with said first means reaches or falls below one or more read data level thresholds and providing said first signal in response thereto.

13. The system of claim 12 wherein said memory device is a Synchronous Dynamic Random Access Memory (SDRAM), an Enhanced SDRAM (ESDRAM), a Virtual Channel Memory (VCM), or a Synchronous Static Random Access Memory (SSRAM).

14. The system of claim 13 wherein one or more of said FIFO read buffers and/or FIFO write buffers are dual ported Random Access Memories (RAM's).

15. A system for selectively affecting data flow to or from a memory device comprising:
a processor;
a memory;
one or more write buffers connected between an output of said processor and an input of said memory, said one or more write buffers having one or more write data level indicators;
one or more read buffers connected between an output of said memory and an input of said processor, said one or more read buffers having one or more read data level indicators; and
a memory manager in communication with said processor, said memory, said one or more read buffers, and said one or more write buffers, said memory manager having said one or more write data level indicators and one or more read data level indicators as input and providing control signals to said one or more write buffers and said one or more read buffers, said control signals dependent upon said one or more write data level indicators and one or more read data level indicators.

16. The system of claim 15 wherein said one or more read buffers and said one or more write buffers are memories capable of providing memory level information.

17. The system of claim 15 wherein said memory manager includes means for comparing data levels in said one or more read buffers and said one or more write buffers to one or more corresponding thresholds and providing said control signals in response thereto, said control signals sufficient to effect data transfer as needed between said buffers, said memory, and said processor.

18. The system of claim 17 further including means for flushing residual data from said one or more read buffers and/or said one or more write buffers.

19. A method for facilitating data flow to and from a memory comprising the steps of:
employing a write buffer to contain write data to be written to said memory and/or employing a read buffer to contain read data to be read from said memory;
comparing data levels in said read buffer and/or said write buffer to one or more corresponding thresholds and providing a signal in response thereto; and
selectively transferring read data to said read buffer from said memory in response to said signal and/or selectively transferring write data in said write buffer to said memory in response to said signal.

20. A method for selectively affecting data flow to or from a memory device comprising the steps of:
intercepting data bound for said memory device or originating from said memory device via one or more buffers;
determining when a data level associated with said one or more buffers reaches or surpasses a threshold and providing a signal in response thereto; and
releasing data from said first means or said memory in response to said signal.

21. A process for selectively affecting data flow between a memory device and a processor comprising:
initiating one or more sub-processes, said one or more sub-processes including first sub-process comprising the steps of:
monitoring data levels associated with one or more read buffers and initiating one or more read memory requests when data levels of one or more of said one or more read buffers are below one or more corresponding read buffer thresholds by desired amounts;
bursting data from said memory device to said one or more read buffers having data levels below corresponding read buffer thresholds by desired amounts until said data levels surpass said corresponding read buffer thresholds by desired amounts; and
returning to said step of monitoring data levels unless a system break occurs, in which case, said first sub-process ends.

22. The process of claim 21 further including a second sub-process comprising the steps of:
observing data levels associated with one or more write buffers and initiating one or more write memory requests when data levels of one or more of said one or more write buffers surpass one or more corresponding write buffer thresholds by desired amounts;
bursting data from said one or more write buffers having data levels surpassing corresponding write buffer thresholds by desired amounts to said memory device until said data levels in said one or more write buffers fall below said corresponding write buffer thresholds by desired amounts; and
returning to said step of observing data levels unless a system break occurs, in which case, said second sub-process ends.

23. The process of claim 22 further including a third sub-process comprising the steps of:
monitoring said processor for processor read requests;
selectively transferring data from one or more read buffers associated with said processor read requests; and
returning to said step of monitoring said processor unless a system break occurs, in which case, said third sub-process ends.

24. The process of claim 23 further including a fourth sub-process comprising the steps of:
observing said processor for processor write requests;
selectively transferring data from said processor to one or more write buffers associated with said processor write requests; and
returning to said step of observing said processor unless a system break occurs, in which case, said fourth sub-process ends.

25. The system of claim 24 wherein said memory device includes plural memories, one memory for each of said one or more read buffers and said one or more write buffers.

26. The system of claim 24 wherein said step of bursting data from said memory device of said first sub-process and said step of bursting data from said one or more write buffers of said second sub-process involve bursting data to/from buffers in order of priority, said priority determined via priority encoding to determine which buffer should be serviced first.

27. The system of claim 26 wherein said memory device includes fewer memories than there are read buffers and write buffers between said memory device and said processor.
